(19) United States
(12) Patent Application Publication
(10) Pub. No.: US 2023/0037518 A1
(43) Pub. Date: Feb. 9, 2023

(54) Recyclable Packaging

(71) Applicant: Colgate-Palmolive Company, New York, NY (US)

(72) Inventor: Jun WANG, Fort Washington, PA (US)

(73) Assignee: Colgate-Palmolive Company, New York, NY (US)

(21) Appl. No.: 17/786,227

(22) PCT Filed: Dec. 11, 2020
(86) PCT No.: PCT/US2020/070899

§ 371 Date: Jun. 16, 2022

Related U.S. Application Data
(60) Provisional application No. 62/952,588, filed on Dec. 23, 2019.

(51) Int. Cl. B32B 27/32; B32B 27/08; B65D 65/46

(52) U.S. Cl. CPC B32B 27/32; B32B 27/08; B65D 65/466; B32B 2439/00; B32B 2307/7163; B32B 2307/518; B32B 2250/242; B32B 2307/732; B32B 2255/205

(57) ABSTRACT

Described herein is a recyclable packaging having an exposed outermost surface, the recyclable packaging comprising: a wall comprising an inner surface opposite an outer surface, the wall having a multi-layer structure that includes a first layer comprising biaxially oriented polypropylene, a second layer comprising metallized cast polypropylene, a third layer comprising cast polypropylene; and a cavity at least partially surrounded by the wall.

### CROSS-REFERENCE TO RELATED APPLICATIONS

This application claims priority to U.S. Provisional Patent Application Ser. No. 62/952,588 filed on Dec. 23, 2019. The disclosure of the above application is incorporated herein by reference.

### BRIEF SUMMARY

The present invention is directed toward a recyclable packaging having an exposed outermost surface, the recyclable packaging comprising: a wall comprising an inner surface opposite an outer surface, the wall having a multi-layer structure that includes: a first layer comprising biaxially oriented polypropylene; a second layer comprising metallized cast polypropylene; a third layer comprising cast polypropylene; and a cavity at least partially surrounded by the wall.

Other embodiments of the present invention include a method of forming a recycleable packaging comprising: laminating together a first layer comprising biaxially oriented polypropylene, a second layer comprising metallized cast polypropylene, and a third layer comprising cast polypropylene to form a multi-layer structure; forming a wall of the recycleable packaging from the multi-layer structure, the wall comprising an inner surface opposite an outer surface; whereby a cavity is located inside of the recycleable packaging and at least partially surrounded by the wall.

Other embodiments of the present invention include a recyclable multi-layer structure comprising: a first layer comprising biaxially oriented polypropylene, the first layer has a thickness of about 15 μm to about 25 μm; a second layer comprising metallized cast polypropylene, the second layer has a thickness of about 15 μm to about 25 μm; and a third layer comprising cast polypropylene, the third layer has a thickness of about 35 μm to about 45 μm.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a sheet according to the present invention;

FIG. 2 is a cross-sectional view of the sheet of FIG. 1 along lines V-V;

FIG. 3 is a packaging formed from the sheet of FIG. 1 according to some embodiments of the present invention; and

FIG. 4 is a cross-sectional view of the packaging of FIG. 3 along lines X-X.

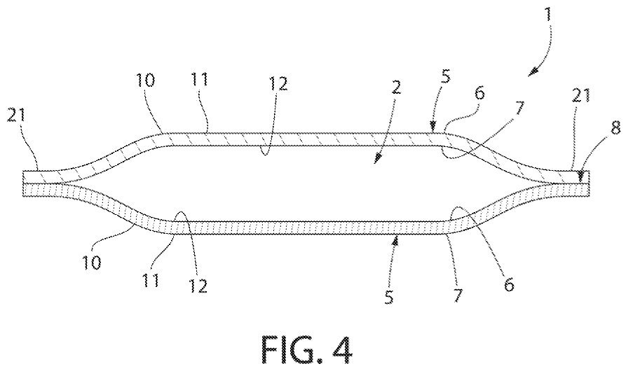

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means +/−5% of the reference value. According to the present application, the term “substantially free” less than about 0.1 wt. % based on the total of the referenced value.

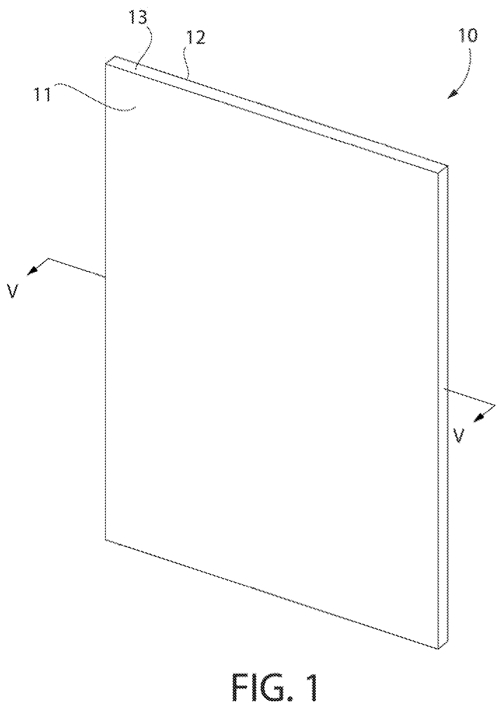

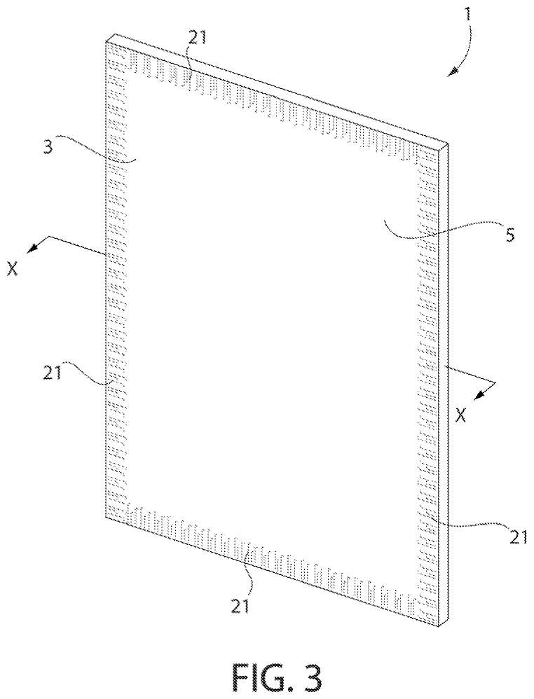

Referring now to FIGS. 1 and 3, the present invention is directed to a sheet 10 and a packaging 1 (also referred as “pouch” or “sachet” or “container”) comprising a wall 5 that may be formed at least in part from the sheet 10. The container 1 may comprise an exposed outer surface 3.

The sheet 10 of the present invention may be flexible—i.e., capable of being non-permanently deformed without fracture. The sheet 10 of the present invention may be recyclable—i.e., capable of being recycled. As discussed in greater detail herein, the container 1 may be a container suitable for containing a personal care composition or item an oral care composition or item.

The term “flexible” refers to the ability of a material to non-permanently deform under an applied stress, whereby the material returns to its original shape after the applied stress is removed.

The walls 5 of the container I may form a chamber 2 (also referred to as a cavity) that is an open volume suitable for housing one or more personal care items, personal care compositions, oral care items, and/or personal care compositions. The wall 5 of the container may comprise an inner surface 7 that is opposite an outer surface 7. The inner surface 7 of the wall 5 may face and surround the chamber 2 of the container 1. The outer surface 6 of the wall 5 may form the exposed outer surface 3 of the container 1.

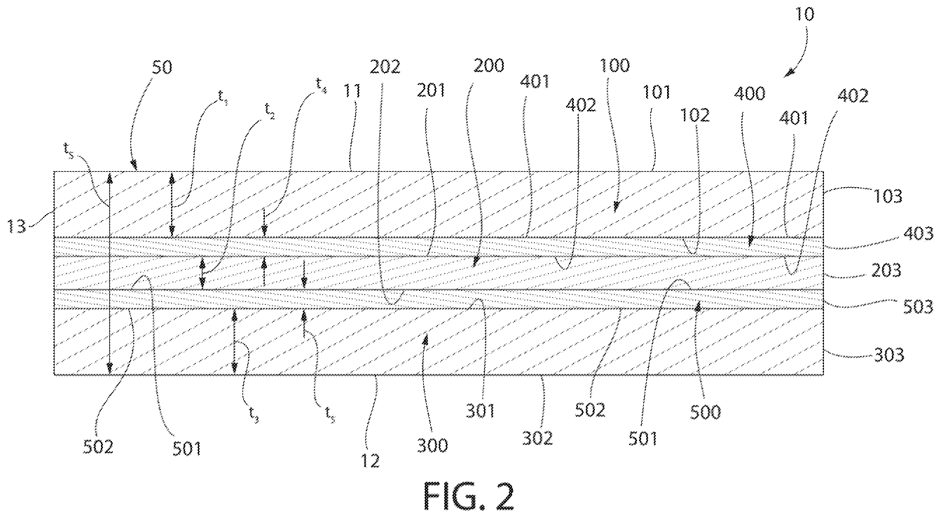

Referring now to FIGS. 1 and 2, the sheet 10 may comprise a first exposed major surface 11 opposite a second exposed major surface 12. The sheet 10 may further comprise an exposed side surface 13 extending between the first and second major exposed surfaces 11, 12. The sheet may have a sheet thickness t_{S} as measured between the first exposed major surface 11 opposite a second exposed major surface 12—the sheet thickness t_{S} ranging from about 50 μm to about 110 μm—including all thickness and sub-ranges there-between. In a preferred embodiment, the sheet thickness t_{S} may range from about 60 μm to about 100 μm—including all thickness and sub-ranges there-between.

In some embodiments, the container 1 may be formed by positioning together the two sheets 10 such the second exposed major surface 12 of the sheets face each other. The edges of the two adjacent sheets 10 may then be sealed together to form a seam 8 between the two adjacent sheets 10. The combination of the two sealed sheets 10 form the container 1, whereby the seam 8 extends about the perimeter of the container 1.

In such embodiments, the first exposed major surface 11 of each sheet 10 may form the outer surface 6 of the wall 5 of the container 1. In such embodiments, the second exposed major surface 12 of each sheet 10 may form the inner surface 7 of the wall 5 of the container 1. In such embodiments, the second exposed major surface 12 of each sheet 10 may surround the chamber 2 of the container 1.

Although not shown, in some embodiments, the container 1 may be formed by folding a single sheet 10 onto itself such that the second exposed major surface 12 of the sheet 10 faces itself to form the chamber 2 of the container 1. At least two adjacent edges of the folded sheet 10 may then be sealed together to form a seam 8, whereby at least one edge is formed by the folded sheet 10.

Referring now to FIG. 2, the sheet 10 may comprise a multi-layer structure 50 comprising a plurality of layers. As discussed in greater detail herein, each of the layers may be independently formed from a polymeric material. In some embodiments, each of the layers independently may consist essentially of polymeric material. In some embodiments of the present invention, each of the layers independently may consist of polymeric material.

Polymeric material is comprised of macromolecule chains. Within each layer of the multi-layer structure 50 that is formed from a polymeric material, the corresponding macromolecule chains (i.e., polymer chains) may exhibit a specific molecular orientation.

Referring now to FIG. 2, the multi-layer structure 50 of the sheet 10 may comprise a first layer 100. The multi-layer structure 50 of the sheet 10 may also comprise a second layer 200. The multi-layer structure 50 of the sheet 10 may comprise a third layer 300. The multi-layer structure 50 of the sheet 10 may comprise a first tie layer 400. The multi-layer structure 50 of the sheet 10 may comprise a second tie layer 500.

The second layer 200 may be positioned between the first layer 100 and the third layer 300. The first tie layer 400 may be located between the first layer 100 and the second layer 200. The second tie layer 500 may be located between the second layer 200 and the third layer 300.

The first layer 100 may have a first major surface 101 opposite a second major surface 102 and a side surface 103 extending there-between. The first layer 100 may have a first thickness tᵢ as measured between the first and second major surfaces 101, 102 of the first layer 100.

The first thickness t₁ of the first layer 100 may range from about 10 μm to about 30 μm—including all thicknesses and sub-ranges there-between. The first thickness t₁ of the first layer 100 may range from about 15 μm to about 25 μm—including all thicknesses and sub-ranges there-between. In some embodiments, the first thickness tᵢ of the first layer 100 may be about 19 μm.

The first layer 100 may be formed of a polymeric material. The polymeric material of t the first layer 100 may be a polyolefin. The polyolefin that may form the first layer 100 may be polypropylene. In some embodiments, the first layer 100 may consist essentially of polypropylene. In some embodiments, the first layer 100 may consist of polypropylene. In some embodiments, the first layer 100 may be free of inorganic material—such as metal.

In some embodiments, the second layer 200 may be substantially free of polyethylene terephthalate. In some embodiments, the second layer 200 may be substantially free of polyethylene.

The first layer 100 may be a biaxially oriented polypropylene film. The term “biaxially oriented” refers to a film that has been oriented in two non-parallel directions. Specifically, a non-oriented laminate sheet may be stretched in the longitudinal (machine) direction at an elevated temperature at a stretching ratio of greater than 1:1. In a non-limiting example, the non-oriented laminate sheet may be stretched at a stretching ratio of about 4:1 to about 10:1. The sheet is also stretched in the transverse direction at an elevated temperature at a stretch ratio greater than 1. In a non-limiting example, the sheet may be stretched in the traverse direction in a stretching ratio of about 4:1 To about 12:1. Once stretched in the machine and traverse direction, the sheet may then be heat set to give a biaxially oriented sheet.

The second layer 200 may have a first major surface 201 opposite a second major surface 202 and a side surface 203 extending there-between. The second layer 200 may have a second thickness t₂ as measured between the first and second major surfaces 201, 202 of the second layer 200.

The second thickness t₂ of the second layer 200 may range from about 10 μm to about 30 μm—including all thicknesses and sub-ranges there-between. The second thickness t₂ of the second layer 200 may range from about 15 μm to about 25 μm—including all thicknesses and sub-ranges there-between. In some embodiments, the second thickness t₂ of the second layer 200 may be about 20 μm.

The second layer 200 may be formed of a polymeric material. The polymeric material of the second layer 200 may be a polyolefin. The polyolefin that may form the second layer 200 may be polypropylene. The second layer 200 may comprise an inorganic material such as a metallization layer.

The metallization layer may be formed from any suitable metal such as aluminum. The metallization may be formed by depositing metal particles on one side of the polymeric material of the second layer 200.

In some embodiments, the second layer 200 may be substantially free of polyethylene terephthalate. In some embodiments, the second layer 200 may be substantially free of polyethylene.

The polymeric material of the second layer 200 may be formed as a cast film. In particular, the second layer 200 may comprise a cast polypropylene as the polymeric material of the second layer 200. The cast polypropylene may be formed by cast film extrusion.

The combination of metallization on the polymeric material of the second layer 200 may result in the second layer 200 exhibiting a barrier characteristics. The barrier characteristic may be suitable for the chamber 2 of the packaging 1 being substantially moisture proof and/or air-tight to the environment outside of the outermost surface 6 of the wall 5. Stated otherwise, the barrier characteristics may prevent moisture and/or air from flowing between the inner surface 7 and the outer surface 7 of the wall 5. The barrier characteristic may include an MVTR value of less than 0.5 g/m^{w}/d. The barrier characteristic may include an Willa value of less than 4 cc/m²/d.

The third layer 300 may have a first major surface 301 opposite a second major surface 302 and a side surface 303 extending there-between. The third layer 300 may have a third thickness t₃ as measured between the first and second major surfaces 301, 302 of the third layer 300.

The third thickness t₃ of the third layer 300 may range from about 20 μm to about 60 μm including all thicknesses and sub-ranges there-between. The third thickness t₃ of the third layer 300 may range from about 30 μm to about 50 μm—including all thicknesses and sub-ranges there-between. In some embodiments, the third thickness t₃ of the third layer 300 may be about 40 μm.

The third layer 300 may be formed of a polymeric material. The polymeric material of the third layer 300 may be a polyolefin. The polyolefin that may form the third layer 300 may be polypropylene. In some embodiments, the third layer 300 may consist essentially of polypropylene. In some embodiments, the third layer 300 may consist of polypropylene. In some embodiments, the third layer 300 may be free of inorganic material—such as metal.

In some embodiments, the third layer 300 may be substantially free of polyethylene terephthalate. In some embodiments, the third layer 300 may be substantially free of polyethylene. The polymeric material of the third layer 300 may be formed as a cast film.

The first tie layer 400 may have a first major surface 401 opposite a second major surface 402 and a side surface 403 extending there-between. The first tie layer 400 may have a fourth thickness t₄ as measured between the first and second major surfaces 401, 402 of the first tie layer 400.

The first tie layer 400 may be formed of a polymeric material. Non-limiting examples of polymeric material suitable for the first tie layer 400 may include polymer resins that are less stiff, have lower modulus, are more flexible and elastic, and tend to have a more plastic stress-strain behavior than the more common polymer film-forming resins such as isotactic polypropylene and high density polyethylene. Acceptable polymer resins also include, but are not limited to, resins having more elastic or amorphous-type functional properties as opposed to more crystalline properties.

Other non-limiting examples of polymeric material suitable for the first tie layer 400 may include a tie resin (e.g., ethylene acrylic acid (EAA), a functionalized polyolefin—such as anhydride-modified LLDPE—and the like). The first tie layer 400 may consist of the tie resin (e.g., ethylene acrylic acid (EAA), a functionalizcd polyolefin—such as anhydride-modified LLDPE—and the like).

Other non-limiting examples of polymeric material that may be suitable for the first tie layer 400 may include impact copolymers or heterophasic polymer blends of acrylonitrile-chloroprene copolymer, acrylonitrile-isoprene copolymer, butadiene-acrylonitrile copolymer, chlorinated polyethylene, chlorosulfonated polyethylene, ethylene-ether polysulfite, ethylene-ethyl acrylate copolymer, ethylene polysulfite, ethylene-propylene copolymer, ethylene-propylene-diene terpolymer, fluoroelastomer, fluorosilicone, hexafluoropropylene-vinylidene fluoride copolymer, isobutene-isoprene copolymer, organopolysiloxane, acrylic ester-butadiene copolymer, polybutadiene, polychloroprene, polyepichlorohydrin, polyisobutene, polyisoprene, polyurethane, styrene-butadiene copolymer, styrene-chloroprene copolymer, polyethylene-butyl graft copolymer, styrene-butadiene-styrene triblock polymer, and blends thereof.

Other non-limiting examples of polymeric material suitable for the first tie layer 400 may include ethylene- and propylene-based polymers including but not limited to, polyolefins selected from the group consisting of propylene (PP) homopolymer ethylene-propylene (EP) copolymer, ethylene-propylene-butylene (EPB) terpolymer, propylene-butylene (PB) copolymer, and blends thereof.

The second tie layer 500 may have a first major surface 501 opposite a second major surface 502 and a side surface 503 extending there-between. The second tie layer 500 may have a fifth thickness t₅ as measured between the first and second major surfaces 501, 502 of the second tie layer 500

The second tie layer 500 may be formed of a polymeric material that is the same or different from the polymeric material previously discussed with respect to the first tie layer 400.

In some embodiments, the first layer 100 may be joined to the second layer 200 by the first tie layer 400 The first tie layer 400 may adhesively bond together the first layer 100 and the second layer 200. In such embodiments, the second major surface 102 of the first layer 100 may contact the first major surface 401 of the first tie layer 400 and the second major surface 402 of the first tie layer 400 may contact the first major surface 201 of the second layer 200

In some embodiments, the second layer 200 may be joined to the third layer 300 by the second tie layer 500. The second tie layer 500 may adhesively bond together the second layer 200 and the third layer 300. In such embodiments, the second major surface 202 of the second layer 200 may contact the first major surface 501 of the second tie layer 500 and the second major surface 502 of the second tie layer 500 may contact the first major surface 301 of the third layer 300.

Although not pictured, some embodiments of the present invention include a multi-layer structure 50 that may omit one or both of the first tie layer 400 and/or second tie layer 500. According to such embodiments, the first layer 100 may be joined directly to the second layer 200. In such embodiments, the second major surface 102 of the first layer 100 may directly contact the first major surface 201 of the second layer 200. According to such embodiments, the second layer 200 may be joined directly to the third layer 300. In such embodiments, the second major surface 202 of the second layer 200 may directly contact the first major surface 301 of the third layer 300.

In a non-limiting example, the multi-layer structure 50 may include the first layer 100, the second layer 200, the second tie layer 500, and the third layer 300—whereby the first tie layer is omitted and the first and second layers 100, 200 are in direct contact. In a non-limiting example, the multi-layer structure 50 may include the first layer 100, the first tie layer 400, the second layer 200, and the third layer 300—whereby the second tie layer is omitted and the second and third layers 200, 300 are in direct contact. In a non-limiting example, the multi-layer structure 50 may include the first layer 100, the second layer 200, and the third layer 300—whereby the first and second tie layers are omitted and the first layer 100 is in direct contact with the second layer 200, and the second layer 200 is in direct contact with the third layer 300.

The packaging 1 of the present invention may be formed by joining together two sheets 10 at a perimeter portion 21. Specifically, the second exposed major surface 12 of each sheet 10 may be positioned immediately adjacent to each other, whereby the perimeter portion 21 is heat-sealed together at an elevated temperature. According to this embodiment, a central portion of each sheet 10 that is circumscribed by the perimeter portion 21 is not heat sealed together, thereby allowing the second exposed major surface 12 of each sheet 10 within the central portion to be separated, thereby creating the chamber 6 of the container.

According to this embodiment, the third layer 300 of the multi-layer structure 50 may have a sealing temperature that is lower than a sealing temperature of first layer 100. The term “sealing temperature” refers to a temperature at which the polymeric material of the respective layer may bond to a separate material.

As a result, the inner surface 7 of the walls 5 of the packaging 1 may form the central portion as the inner surface 7 of the walls 5 of the packaging represent the unsealed portions of the second exposed major surface 12 of the sheet.

1. A recyclable packaging having an exposed outermost surface, the recyclable packaging comprising:
a wall comprising an inner surface opposite an outer surface, the wall having a multi-layer structure that includes:
a first layer comprising biaxially oriented polypropylene;
a second layer comprising metallized cast polypropylene;
a third layer comprising cast polypropylene; and
a cavity at least partially surrounded by the wall.

2. The recyclable packaging according to claim 1, wherein the inner surface of the wall is formed by the third layer.

3. The recyclable packaging according to claim 1, wherein the outer surface of the wall is formed by the first layer.

4. (canceled)

5. The recyclable packaging according to claim 1, wherein the first layer has a thickness of about 15 μm to about 25 μm.

6. The recyclable packaging according to claim 1, wherein the second layer has a thickness of about 15 μm to about 25 μm.

7. The recyclable packaging according to claim 1, wherein the third layer has a thickness of about 35 μm to about 45 μm.

8. The recyclable packaging according to claim 1, wherein the inner surface of the wall faces the cavity and the outer surface of the wall forms the exposed outermost surface of the recyclable packaging.

9. The recyclable packaging according to claim 1, wherein the first layer is substantially free of metallization.

10. The recyclable packaging according to claim 1, wherein the third layer is substantially free of metallization.

11. A method of forming a recycleable packaging comprising:
laminating together a first layer comprising biaxially oriented polypropylene, a second layer comprising metallized cast polypropylene, and a third layer comprising cast polypropylene to form a multi-layer structure;
forming a wall of the recycleable packaging from the multi-layer structure, the wall comprising an inner surface opposite an outer surface;
whereby a cavity is located inside of the recycleable packaging and at least partially surrounded by the wall.

12. The method according to claim 11, wherein the inner surface of the wall is formed by the third layer, the outer surface of the wall is formed by the first layer, and the second layer is located between the first and third layers.

13. (canceled)

14. (canceled)

15. The method according to claim 11, wherein the first layer has a thickness of about 15 μm to about 25 μm.

16. The method according to claim 11, wherein the second layer has a thickness of about 15 μm to about 25 μm.

17. The method according to claim 11, wherein the third layer has a thickness of about 35 μm to about 45 μm.

18. The method according to claim 11, wherein the inner surface of the wall faces the cavity and the outer surface of the wall forms the exposed outermost surface of the recyclable packaging.

19. The method according to claim 11, wherein the first layer and the third layer are substantially free of metallization.

20. (canceled)

21. A recyclable multi-layer structure comprising:
a first layer comprising biaxially oriented polypropylene, the first layer has a thickness of about 15 μm to about 25 μm;
a second layer comprising metallized cast polypropylene, the second layer has a thickness of about 15 μm to about 25 μm; and
a third layer comprising cast polypropylene, the third layer has a thickness of about 35 μm to about 45 μm.

22. The recyclable multi-layer structure of claim 21, wherein the first layer is substantially free of metallization.

23. The recyclable multi-layer structure according to claim 21, wherein the third layer is substantially free of metallization.

24. The recyclable multi-layer structure according to claim 21, wherein the multi-layer structure is a sheet having a first major exposed surface opposite a second major exposed surface, wherein the first major exposed surface is formed by the first layer and the second major exposed surface is formed by the third layer, and wherein the second layer is located between the first layer and the third layer.

25.-27. (canceled)
